(19) United States
(12) Patent Application Publication
(10) Pub. No.: US 2020/0094572 A1
(43) Pub. Date: Mar. 26, 2020

(54) PRINTING APPARATUS, PRINTING SYSTEM, PRINTING METHOD

(71) Applicant: SCREEN HOLDINGS CO., LTD., Kyoto (JP)

(72) Inventor: Shogo Muto, kyoto (JP)

(21) Appl. No.: 16/572,023

(22) Filed: Sep. 16, 2019

(30) Foreign Application Priority Data
Sep. 21, 2018 (JP) 2018-177-462

(51) Int. Cl. B41J 2/175

(52) U.S. Cl. CPC B41J 2/17566; B41J 2/17596

(57) ABSTRACT

A printing apparatus, comprises: a discharge head; a recovery tank that stores ink recovered from the discharge head; a supply tank that stores ink to be supplied to the discharge head; a circulation pump that performs an ink circulation operation of circulating ink in a circulation path that returns to the recovery tank after reaching the discharge head from the recovery tank via the supply tank; a first negative pressure applying part configured to apply a negative pressure to the supply tank; a second negative pressure applying part configured to apply a negative pressure to the recovery tank; a first solenoid valve to cut off the supply tank and the recovery tank when being energized and cause the supply tank and the recovery tank to communicate when not being energized; and a power supply part configured to supply electric power to the circulation pump and the first solenoid valve.

### CROSS REFERENCE TO RELATED APPLICATION

The disclosure of Japanese Patent Application No. 2018-177462 filed on Sep. 21, 2018 including specification, drawings and claims is incorporated herein by reference in its entirety.

### BACKGROUND OF THE INVENTION

### 1. Field of the Invention

The present invention relates to a technology for circularly supplying ink to a discharge head which discharges the ink from a nozzle.

### 2. Description of the Related Art

In a printer disclosed in Japanese Patent Application Laid Open Gazette No. 2014-200969 (Patent Document 1), a supply tank (pressurizing tank) for supplying ink to a discharge head by using a water head difference and a recovery tank (negative pressure tank) for recovering ink from the discharge head are provided, and the ink is circularly supplied to the discharge head by a circulation pump disposed between these tanks.

### SUMMARY OF THE INVENTION

In the above printer, the pressure inside the recovery tank is lower than that inside the supply tank due to the supply of a negative pressure from the negative pressure tank connected thereto. Then, the ink is moved from the supply tank to the recovery tank through the discharge head due to a pressure difference between the recovery tank and the supply tank. The moved ink is flowed from the recovery tank back to the supply tank by the circulation pump. When the circulation pump is stopped due to a power failure, however, the flow back of the ink from the recovery tank to the supply tank is stopped. At that time, there are some cases where the ink overflows from the recovery tank into the negative pressure tank since the ink has flowed from the supply tank into the recovery tank beyond the capacity of the recovery tank.

The present invention is intended to solve the above problem, and it is an object of the present invention to provide a technology to make it possible to suppress the overflow of ink into a negative pressure applying part which supplies a negative pressure when a circulation pump which circularly supplies the ink from a recovery tank to a discharge head through a supply tank is stopped due to a power failure.

A printing apparatus according to the invention, comprises: a discharge head that discharges ink from a nozzle; a recovery tank that stores ink recovered from the discharge head; a supply tank that stores ink to be supplied to the discharge head; a circulation pump that transfers the ink from the recovery tank to the supply tank with supplied electric power to perform an ink circulation operation of circulating ink in a circulation path that returns to the recovery tank after reaching the discharge head from the recovery tank via the supply tank; a first negative pressure applying part configured to apply a negative pressure to the inside of the supply tank; a second negative pressure applying part configured to apply a negative pressure to the inside of the recovery tank; a first solenoid valve provided between the supply tank and the recovery tank, to cut off the supply tank and the recovery tank from each other when being energized and cause the supply tank and the recovery tank to communicate with each other when not being energized; and a power supply part configured to supply electric power to the circulation pump and the first solenoid valve.

A printing method according to the invention, comprises: performing a printing operation of discharging ink from a nozzle of a discharge head while transferring the ink from a recovery tank to which a negative pressure is applied to a supply tank to which a negative pressure is applied by a circulate pump to which electric power is supplied to circulate ink in a circulation path that returns to the recovery tank after reaching the discharge head from the recovery tank via the supply tank; and supplying electric power to a solenoid valve provided between the supply tank and the recovery tank in parallel with the printing operation, wherein the solenoid valve cuts off the supply tank and the recovery tank from each other when being energized and causes the supply tank and the recovery tank to communicate with each other when not being energized.

In the present invention (the printing apparatus, the printing method) having such a configuration, the circulation pump transfers the ink from the recovery tank to the supply tank to circulate the ink in the circulation path that returns to the recovery tank after reaching the discharge head from the recovery tank via the supply tank. Further, the solenoid valve is provided between the supply tank and the recovery tank and cuts off the supply tank and the recovery tank from each other when being energized. Therefore, the solenoid valve does not inhibit generation of a pressure difference between the supply tank and the recovery tank by the first negative pressure applying part and the second negative pressure applying part. On the other hand, this solenoid valve causes the supply tank and the recovery tank to communicate with each other when not being energized. Therefore, when the circulation pump is stopped due to a power failure, it is possible to quickly cancel the pressure difference between the supply tank and the recovery tank and suppress the inflow of the ink from the supply tank into the recovery tank. As a result, it becomes possible to suppress the overflow of the ink into one of the negative pressure applying parts.

The above and further objects and novel features of the invention will more fully appear from the following detailed description when the same is read in connection with the accompanying drawing. It is to be expressly understood, however, that the drawing is for purpose of illustration only and is not intended as a definition of the limits of the invention.

### BRIEF DESCRIPTION OF THE DRAWINGS

FIG. 1 is a front elevational view schematically showing one example of a printing system in accordance with the present invention.

FIG. 2 is a front elevational view schematically showing a prestage printer included in the printing system of FIG. 1.

FIG. 3 is a front elevational view schematically showing a post-stage printer included in the printing system of FIG. 1.

FIG. 4 is a view schematically showing a configuration of the discharge head and an ink supply apparatus which supplies ink to the discharge head.

FIG. 5 is a view schematically showing a configuration of the discharge head and an ink supply apparatus which supplies ink to the discharge head.

### DETAILED DESCRIPTION OF THE PREFERRED EMBODIMENTS

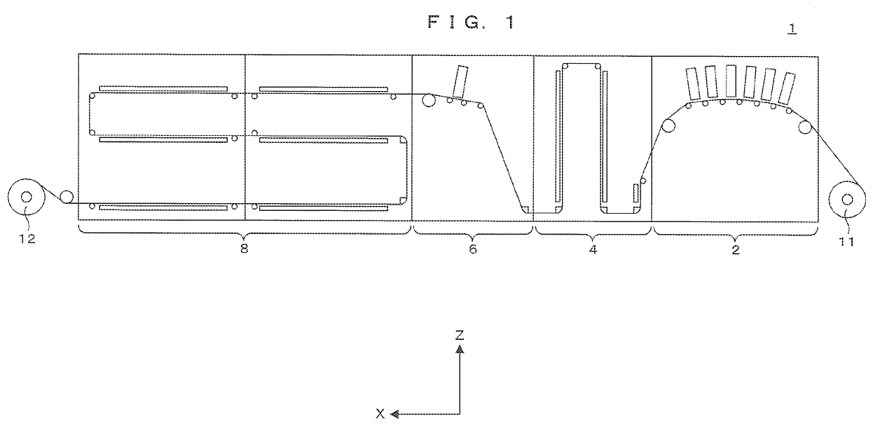

FIG. 1 is a front elevational view schematically showing one example of a printing system in accordance with the present invention. In FIG. 1 and the following figures, a horizontal direction X and a vertical direction Z are shown as appropriate. As shown in FIG. 1, a printing system 1 includes a configuration in which a prestage printer 2, a prestage dryer 4, a post-stage printer 6, and a post-stage dryer 8 which have the same height as one another are arranged in this order in the horizontal direction X. This printing system 1 transfers a printing medium M from a unwind roll 11 to a rewind roll 12 in a roll-to-roll process while causing the prestage dryer 4 to dry the printing medium M printed by the prestage printer 2 and causing the post-stage dryer 8 to dry the printing medium M printed by the post-stage printer 6. Herein, an exemplary case where printing is performed on the printing medium M which is a transparent film by using water-based ink will be shown. Further, hereinafter, among both surfaces of the printing medium M, the surface on which an image is printed is referred to as a front surface and the other surface opposite to the front surface is referred to as a back surface as appropriate.

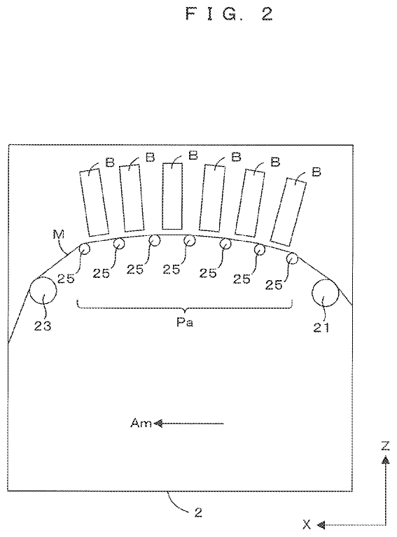

FIG. 2 is a front elevational view schematically showing a prestage printer included in the printing system of FIG. 1. In the prestage printer 2, the printing medium M is fed along a feed direction Am directed from right to left in this figure. This prestage printer 2 has a loading roller 21 for loading the printing medium M fed from the feed roll 11 and an unloading roller 23 for unloading the printing medium M toward the prestage dryer 4. The loading roller 21 and the unloading roller 23 wind up the back surface of the printing medium M from below and drive the printing medium M in the feed direction Am. Further, the prestage printer 2 has a plurality of backup rollers 25 disposed between the loading roller 21 and the unloading roller 23 in the feed direction Am. These backup rollers 25 each wind up the back surface of the printing medium M to be fed in the feed direction Am from below, to thereby support the printing medium M.

Among the plurality of backup rollers 25, between the backup roller 25 on the most upstream side and the backup roller 25 on the most downstream side in the feed direction Am, a prestage print path Pa is formed. The backup roller 25 on the most upstream side and the backup roller 25 on the most downstream side support the printing medium M at the same height, and each of the backup rollers 25 disposed inside the prestage print path Pa supports the printing medium M at a higher height as disposed more inside.

Further, the prestage printer 2 includes a plurality of print bars B facing the front surface of the printing medium M, the plurality of print bars B are aligned in the feed direction Am above the printing medium M fed along the prestage print path Pa. Specifically, each print bar B is disposed with respect to the front surface of the printing medium M proceeding between the two adjacent backup rollers 25 and discharges ink by the inkjet method onto the front surface of the printing medium M supported on both sides by the two backup rollers 25. In the exemplary case shown herein, provided are six print bars B including four print bars B that discharge inks of four process colors (yellow, magenta, cyan, and black) and two print bars B that discharge inks of two special colors (orange and violet). Therefore, the prestage printer 2 can print a color image on the front surface of the printing medium M by using the six print bars B which discharge color inks of different colors from one another.

The printing medium M on which the image is printed in the prestage print path Pa goes down diagonally between the backup roller 25 on the most downstream side of the prestage print path Pa and the unloading roller 23 to reach the unloading roller 23. This unloading roller 23 winds up the back surface of the printing medium M from below on the downstream side of the plurality of backup rollers 25 in the feed direction Am. Then, the unloading roller 23 unloads the printing medium M to the prestage dryer 4. Further, the unloading roller 23 is a suction roller that sucks the back surface of the printing medium M, and suppresses transmission of the oscillation of the printing medium M from the prestage dryer 4 to the prestage printer 2 to stabilize the position of the printing medium M in the prestage print path Pa. As a result, it becomes possible to suppress the feed of the printing medium M in the prestage dryer 4 from affecting the printing in the prestage printer 2.

As shown in FIG. 1, the prestage dryer 4 dries the printing medium M while turning the feed direction Am of the printing medium M to the vertical direction Z as appropriate. Then, the printing medium M dried by the prestage dryer 4 is unloaded from the prestage dryer 4 to the post-stage printer 6.

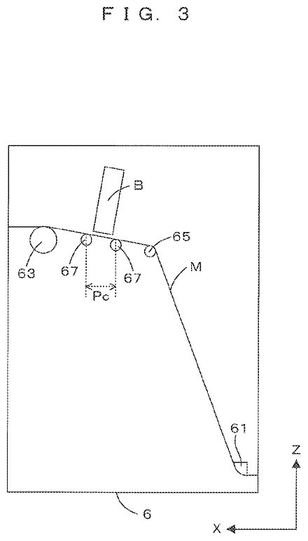

FIG. 3 is a front elevational view schematically showing a post-stage printer included in the printing system of FIG. 1. The post-stage printer 6 has an air turn bar 61 for bending the printing medium M diagonally upward, which is unloaded from the prestage dryer 4 in the horizontal direction X. This air turn bar 61 winds up the front surface of the printing medium M while providing a clearance between itself and the front surface of the printing medium M by injection of air. Further, the post-stage printer 6 has an unloading roller 63 for unloading the printing medium M to the post-stage dryer 8 and a conveying roller 65 disposed between the air turn bar 61 and the unloading roller 63. The conveying roller 65 and the unloading roller 63 wind up the back surface of the printing medium M from below and drive the printing medium M in the feed direction Am.

Furthermore, the post-stage printer 6 has two backup rollers 67 between the conveying roller 65 and the unloading roller 63. Between the two backup rollers 67, a post-stage print path Pc is formed. Further, the post-stage printer 6 includes a print bar B facing the front surface of the printing medium M above the printing medium M conveyed along the post-stage print path Pc. Specifically, the print bar B is disposed with respect to the front surface of the printing medium M proceeding between the two backup rollers 67 and discharges ink by the inkjet method onto the front surface of the printing medium M supported on both sides by the two backup rollers 67. In the exemplary case shown herein, the print bar B discharges white ink. Therefore, the post-stage printer 6 can print a white background image on the front surface of the printing medium M by using the print bar B with respect to the color image printed by the prestage printer 2.

The printing medium M on which the image is printed in the post-stage print path Pc goes up diagonally between the backup roller 67 on the most downstream side of the post-stage print path Pc and the unloading roller 63 to reach the unloading roller 63. This unloading roller 63 winds up the printing medium M from below on the downstream side of the two backup rollers 67 in the feed direction Am. Thus, the unloading roller 63 unloads the printing medium M to the post-stage dryer 8 along a path in which the printing medium M moves in the horizontal direction X by winding up the printing medium M which has been going up diagonally from the post-stage print path Pc. Further, the unloading roller 63 is a suction roller that sucks the back surface of the printing medium M, and suppresses transmission of the oscillation of the printing medium M from the post-stage dryer 8 to the post-stage printer 6 to stabilize the position of the printing medium M in the post-stage print path Pc. As a result, it becomes possible to suppress the feed of the printing medium M in the post-stage dryer 8 from affecting the printing in the post-stage printer 6.

As shown in FIG. 1, the post-stage dryer 8 dries the printing medium M while turning the feed direction Am of the printing medium M to the horizontal direction X as appropriate. Then, the printing medium M dried by the post-stage dryer 8 is unloaded from the post-stage dryer 8 and wound up by the rewind roll 12.

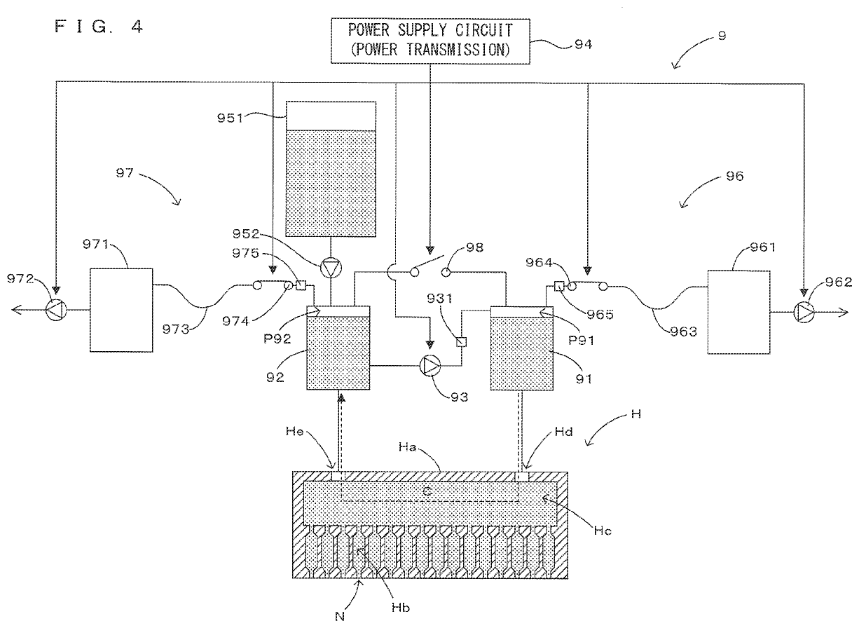

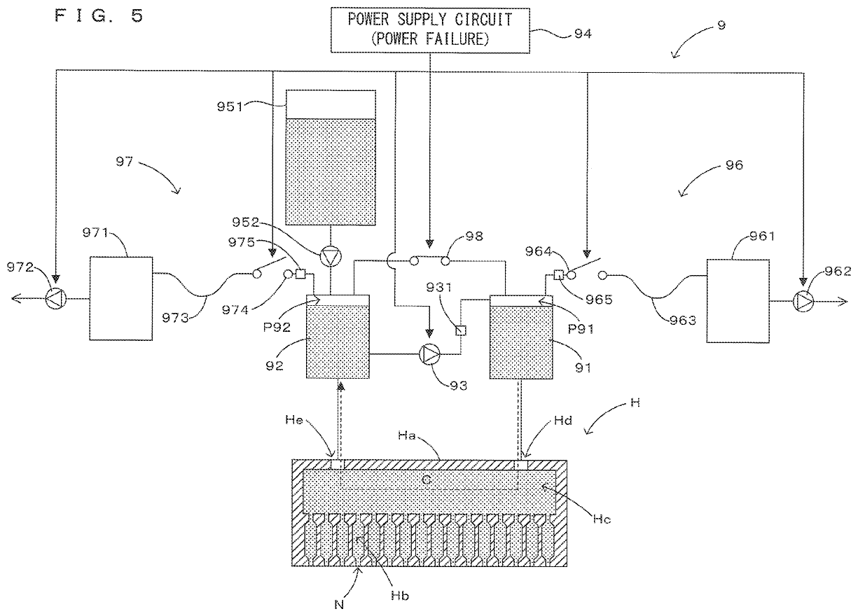

As described above, the print bar B included in each of the prestage printer 2 and the post-stage printer 6 discharges the ink by the inkjet method. Specifically, on the bottom of the print bar B, a plurality of discharge heads H (FIGS. 4 and 5) each of which discharges the ink onto the printing medium M from nozzles N are arranged in a longitudinal direction of the print bar B.

FIGS. 4 and 5 are views each schematically showing a configuration of the discharge head and an ink supply apparatus which supplies ink to the discharge head, and FIG. 4 shows a state during power transmission and FIG. 5 shows a state during a power failure. Each of the prestage printer 2 and the prestage dryer 4 includes an ink supply apparatus 9 which is used to supply the ink to the discharge heads H included in each print bar B. Further, since the ink supply apparatuses 9 which supply the ink to the discharge heads H in each print bar B have a common configuration, description will be made hereinafter with one discharge head H taken as an example.

As shown in FIGS. 4 and 5, the discharge head H has a housing Ha, and a plurality of nozzles N are arranged and opened in the bottom of the housing Ha. Inside the housing Ha, a plurality of cavities Hb communicating with the plurality of nozzles N, respectively, and an ink supply chamber Hc communicating with the plurality of cavities Hb are provided, and the ink supplied from the ink supply chamber Hc is stored in the cavities Hb. Then, a piezoelectric element provided in each of the cavities Hb extrudes the ink from the cavity Hb and the ink is thereby discharged from the nozzle N which communicates with the cavity Hb. Further, the specific method of discharging the ink is not limited to the above method using the piezoelectric element but may be a thermal method in which the ink is heated. Furthermore, in an upper portion of the discharge head H, an ink inflow port Hd and an ink outflow port He are opened, and the ink flows into the ink supply chamber Hc from the ink supply apparatus 9 through the ink inflow port Hd and flows out from the ink supply chamber Hc through the ink outflow port He to the ink supply apparatus 9.

The ink supply apparatus 9 includes a supply tank 91 connected to the ink inflow port Hd through a pipe and a recovery tank 92 connected to the ink outflow port He through a pipe, and the ink is stored in each of the supply tank 91 and the recovery tank 92. Further, the ink supply apparatus 9 includes a circulation pump 93 that transfers the ink from the recovery tank 92 to the supply tank 91 and a degassing filter 931 disposed between the circulation pump 93 and the supply tank 91, and the degassing filter 931 removes gas from the ink flowing out from the circulation pump 93 before flowing into the supply tank 91.

This ink supply apparatus 9 has a power supply circuit 94 that supplies electric power to the constituent elements of the apparatus. Then, the circulation pump 93 transfers the ink from the recovery tank 92 to the supply tank 91 by using the electric power supplied from the power supply circuit 94. The circulation pump 93 thereby performs an ink circulation operation of circulating the ink in a circulation path C returns to the recovery tank 92 after reaching the ink supply chamber Hc of the discharge head H from the recovery tank 92 via the supply tank 91.

Further, the ink supply apparatus 9 includes a main tank 951 capable of storing a large amount of ink and a main pump 952 that transfers the ink from the main tank 951 to the recovery tank 92. Then, when the amount of ink circulating in the circulation path C is reduced by the discharge of the ink from the nozzles N, the main pump 952 supplements the ink to the recovery tank 92 from the main tank 951 by using the electric power supplied from the power supply circuit 94.

Furthermore, the ink supply apparatus 9 includes a supply-side negative pressure applying part 96 (hereinafter, referred to as a “negative pressure applying part 96” as appropriate) configured to apply a negative pressure to the supply tank 91. The negative pressure applying part 96 includes a negative pressure tank 961, a negative pressure pump 962 that decompresses the inside of the negative pressure tank 961 by sucking gas (air) from the negative pressure tank 961, and a flexible negative pressure tube 963 having one end connected to the negative pressure tank 961. In the negative pressure applying part 96, the negative pressure pump 962 exhausts gas from the inside of the negative pressure tank 961 by using the electric power supplied from the power supply circuit 94. The negative pressure generated thus inside the negative pressure tank 961 by the negative pressure pump 962 is given to the supply tank 91 through the negative pressure tube 963.

Further, the negative pressure applying part 96 includes a solenoid valve 964 provided between the other end of the negative pressure tube 963 and the supply tank 91. This solenoid valve 964 is a valve of normally closed type. Therefore, during the power transmission shown in FIG. 4, the solenoid valve 964 forms a communication state by using the electric power supplied from the power supply circuit 94 and the negative pressure inside the negative pressure tank 961 is thereby given to the inside of the supply tank 91 through the negative pressure tube 963 and the solenoid valve 964. On the other hand, during the power failure shown in FIG. 5, since the power supply from the power supply circuit 94 to the solenoid valve 964 is lost, the solenoid valve 964 forms a cut-off state and the application of the negative pressure from the negative pressure tank 961 to the supply tank 91 is cut off.

Furthermore, the negative pressure applying part 96 has a check filter 965 between the supply tank 91 and the solenoid valve 964. This check filter 965 inhibits passage of the ink from the supply tank 91 toward the negative pressure tank 961 while permitting passage of gas from the supply tank 91 toward the negative pressure tank 961. Thus, the check filter 965 prevents inflow of the ink from the supply tank 91 into the negative pressure tube 963.

Further, the ink supply apparatus 9 includes a recovery-side negative pressure applying part 97 (hereinafter, referred to as a “negative pressure applying part 97” as appropriate) configured to apply a negative pressure to the recovery tank 92. The negative pressure applying part 97 includes a negative pressure tank 971, a negative pressure pump 972 that decompresses the inside of the negative pressure tank 971 by sucking gas (air) from the negative pressure tank 971, and a flexible negative pressure tube 973 having one end connected to the negative pressure tank 971. In the negative pressure applying part 97, the negative pressure pump 972 exhausts gas from the inside of the negative pressure tank 971 by using the electric power supplied from the power supply circuit 94. The negative pressure generated thus inside the negative pressure tank 971 by the negative pressure pump 972 is given to the recovery tank 92 through the negative pressure tube 973.

Furthermore, the negative pressure applying part 97 includes a solenoid valve 974 provided between the other end of the negative pressure tube 973 and the recovery tank 92. This solenoid valve 974 is a valve of normally closed type. Therefore, during the power transmission shown in FIG. 4, the solenoid valve 974 forms a communication state by using the electric power supplied from the power supply circuit 94 and the negative pressure inside the negative pressure tank 971 is thereby given to the inside of the recovery tank 92 through the negative pressure tube 973 and the solenoid valve 974. On the other hand, during the power failure shown in FIG. 5, since the power supply from the power supply circuit 94 to the solenoid valve 974 is lost, the solenoid valve 974 forms a cut-off state and the application of the negative pressure from the negative pressure tank 971 to the recovery tank 92 is cut off.

Further, the negative pressure applying part 97 has a check filter 975 between the recovery tank 92 and the solenoid valve 974. This check filter 975 inhibits passage of the ink from the recovery tank 92 toward the negative pressure tank 971 while permitting passage of gas from the recovery tank 92 toward the negative pressure tank 971. Thus, the check filter 975 prevents inflow of the ink from the recovery tank 92 into the negative pressure tube 973.

The pressure P92 (atmospheric pressure) inside the recovery tank 92 is lower than the pressure P91 (atmospheric pressure) inside the supply tank 91, and the ink is thereby moved from the supply tank 91 to the recovery tank 92 through the circulation path C. If this state continues, a liquid surface of the supply tank 91 becomes lower and a liquid surface of the recovery tank 92 becomes higher, and a meniscus required for the nozzle N of the discharge head H does not occur. Then, the circulation pump 93 circulates the ink from the recovery tank 92 to the supply tank 91, to thereby keep the respective liquid surfaces of the supply tank 91 and the recovery tank 92 at a constant level.

Further, the ink supply apparatus 9 includes a solenoid valve 98 provided between the recovery tank 92 and the supply tank 91, and in other words, the solenoid valve 98 is provided in parallel with the circulation pump 93 between the recovery tank 92 and the supply tank 91. This solenoid valve 98 is a valve of normally open type. Therefore, during the power transmission shown in FIG. 4, the solenoid valve 98 forms a cut-off state by using the electric power supplied from the power supply circuit 94 and the connection between the recovery tank 92 and the supply tank 91 through the solenoid valve 98 is cut off. On the other hand, during the power failure shown in FIG. 5, since the power supply from the power supply circuit 94 to the solenoid valve 98 is lost, the solenoid valve 98 forms a communication state, and the recovery tank 92 and the supply tank 91 are connected to each other through the solenoid valve 98.

The ink supply apparatus 9 in accordance with the present embodiment described above circulates the ink in the circulation path C which returns to the recovery tank 92 after reaching the discharge head H from the recovery tank 92 via the supply tank 91 by transferring the ink from the recovery tank 92 to the supply tank 91 by the circulation pump 93. Further, the solenoid valve 98 is provided between the supply tank 91 and the recovery tank 92 and cuts off the supply tank 91 and the recovery tank 92 from each other when being energized (FIG. 4). Therefore, the solenoid valve 98 does not inhibit generation of the pressure difference (=P91−P92) between the supply tank 91 and the recovery tank 92. On the other hand, this solenoid valve 98 causes the supply tank 91 and the recovery tank 92 to communicate with each other when not being energized (FIG. 5). Therefore, when the circulation pump 93 is stopped due to the power failure, it is possible to quickly cancel the pressure difference between the supply tank 91 and the recovery tank 92 and suppress the inflow of the ink from the supply tank 91 to the recovery tank 92 through the ink supply chamber Hc of the discharge head H. As a result, it becomes possible to suppress the overflow (in other words, backflow) of the ink from the recovery tank 92 into the negative pressure tank 971.

In the above-described configuration, the negative pressure generated in the negative pressure tank 971 by decompression using the negative pressure pump 972 is given to the recovery tank 92. Therefore, if the negative pressure tank 971 and the recovery tank 92 communicate with each other during the power failure, the pressure of the negative pressure tank 971 also becomes higher as the pressure of the recovery tank 92 communicating with the supply tank 91 by the solenoid valve 98 increases. For this reason, it takes more time to generate a desired negative pressure by decompressing the negative pressure tank 971 in the recovery from the power failure. In contrast to this, in the negative pressure applying part 97 of the present embodiment, the negative pressure generated in the negative pressure tank 971 by the negative pressure pump 972 is given to the recovery tank 92 through the solenoid valve 974 connected to the recovery tank 92. This solenoid valve 974 causes the recovery tank 92 and the negative pressure tank 971 to communicate with each other when being energized and on the other hand, cuts off the recovery tank 92 and the negative pressure tank 971 from each other when not being energized. Thus, since the solenoid valve 974 cuts off the recovery tank 92 and the negative pressure tank 971 from each other during the power failure, it is possible to keep the pressure of the negative pressure tank 971 at the negative pressure P92 and quickly generate the negative pressure in the negative pressure tank 971 in the recovery from the power failure. Similarly, also in the negative pressure applying part 96, since the solenoid valve 964 cuts off the supply tank 91 and the negative pressure tank 961 from each other during the power failure, it is possible to keep the pressure of the negative pressure tank 961 at the negative pressure P91 and quickly generate the negative pressure in the negative pressure tank 961 in the recovery from the power failure.

Further, the negative pressure applying part 97 further has the flexible negative pressure tube 973 connected to the negative pressure tank 971, and gives the negative pressure generated in the negative pressure tank 971 by the negative pressure pump 972 to the recovery tank 92 through the negative pressure tube 973. In such a configuration, the flexible negative pressure tube 973 is bent into a U-shape by its own weight or a piping path. For this reason, if the ink overflowed from the recovery tank 92 flows into the negative pressure tube 973 during the power failure, the ink is accumulated in the lowest portion of the negative pressure tube 973 and it thereby becomes necessary to perform an operation of removing the accumulated ink in the recovery from the power failure. In contrast to this, in the present embodiment, during the power failure, the recovery tank 92 and the supply tank 91 communicate with each other through the solenoid valve 98 and it is thereby possible to quickly cancel the pressure difference between the recovery tank 92 and the supply tank 91. For this reason, it is possible to suppress the inflow of the ink overflowed from the recovery tank 92 into the negative pressure tube 973 of the negative pressure applying part 97 and reduce the operation required in the recovery from the power failure. The same applies to the negative pressure applying part 96.

Furthermore, the negative pressure applying part 97 has the check filter 975 which inhibits the passage of the ink while permitting the passage of gas in the direction from the recovery tank 92 toward the negative pressure tank 971, and the check filter 975 prevents the inflow of the ink from the recovery tank 92 into the negative pressure tube 973. This check filter 975 can be used for the purpose of preventing the inflow of the ink from the recovery tank 92 into the negative pressure tube 973 due to some cause, which is not limited to the power failure. When the check filter 975 is wet with the ink, however, the aeration property required for the check filter 975 is reduced. For this reason, when the ink overflowed from the recovery tank 92 toward the negative pressure tube 973 flows into the check filter 975 during the power failure, it becomes necessary to perform an operation of replacing the check filter with another one in the recovery from the power failure. In contrast to this, in the present embodiment, during the power failure, the recovery tank 92 and the supply tank 91 communicate with each other through the solenoid valve 98 and it is thereby possible to quickly cancel the pressure difference between the recovery tank 92 and the supply tank 91. For this reason, it is possible to suppress the inflow of the ink overflowed from the recovery tank 92 into the check filter 975 of the negative pressure applying part 97 during the power failure and reduce the operation required in the recovery from the power failure. The same applies to the negative pressure applying part 96.

In the above-described embodiment, the printing system 1 corresponds to one example of a “printing system” of the present invention, each of the prestage dryer 4 and the post-stage dryer 8 corresponds to one example of a “drying apparatus” of the present invention, each of the prestage printer 2 and the post-stage printer 6 corresponds to one example of a “printing apparatus” of the present invention, the discharge head H corresponds to one example of a “discharge head” of the present invention, the nozzle N corresponds to one example of a “nozzle” of the present invention, the recovery tank 92 corresponds to one example of a “recovery tank” of the present invention, the supply tank 91 corresponds to one example of a “supply tank” of the present invention, the circulation pump 93 corresponds to one example of a “circulation pump” of the present invention, the circulation path C corresponds to one example of a “circulation path” of the present invention, the solenoid valve 98 corresponds to one example of a “first solenoid valve” of the present invention, the power supply circuit 94 corresponds to one example of a “power supply part” of the present invention, the negative pressure applying part 96 corresponds to one example of a “first negative pressure applying part” of the present invention, the solenoid valve 964 corresponds to one example of a “third solenoid valve” of the present invention, the negative pressure pump 962 corresponds to one example of a “first negative pressure pump” of the present invention, the negative pressure tank 961 corresponds to one example of a “first negative pressure tank” of the present invention, the negative pressure tube 963 corresponds to one example of a “first negative pressure tube” of the present invention, the check filter 965 corresponds to one example of a “first check filter” of the present invention, the negative pressure applying part 97 corresponds to one example of a “second negative pressure applying part” of the present invention, the solenoid valve 974 corresponds to one example of a “second solenoid valve” of the present invention, the negative pressure pump 972 corresponds to one example of a “second negative pressure pump” of the present invention, the negative pressure tank 971 corresponds to one example of a “second negative pressure tank” of the present invention, the negative pressure tube 973 corresponds to one example of a “second negative pressure tube” of the present invention, and the check filter 975 corresponds to one example of a “second check filter” of the present invention.

The present invention is not limited to the above-described embodiment, but numerous modifications and variations other than those described above can be devised without departing from the scope of the invention. In the negative pressure applying part 97, for example, the solenoid valve 974 or the check filter 975 does not necessarily need to be provided but may be omitted as appropriate. The same applies to the negative pressure applying part 96.

Further, the supplement destination of the ink from the main tank 951 is not limited to the recovery tank 92 but may be the supply tank 91.

Furthermore, the types of color inks to be discharged onto the printing medium M from the prestage printer 2 are not limited to the six colors described above.

Further, there may be a configuration where a printer for discharging the white ink is provided on the upstream side from the prestage printer 2 in the feed direction Am and the white ink is discharged onto the printing medium M and then the color inks are discharged on the printing medium M.

Furthermore, printing of the white ink onto the printing medium M may be performed by analog printing such as flexography, photogravure, or the like.

Further, the prestage printer 2 may cause the printing medium M to stop on a platen and discharge the color inks from the nozzles N while operating the print bars B in the orthogonal direction Ar.

Furthermore, the material of the printing medium M is not limited to a film but may be paper or the like.

Further, the type of ink is not limited to the water-based ink but may be latex ink, solvent ink, or UV (Ultra Violet) ink. In a case of using the UV ink, a light irradiation apparatus that irradiates the UV ink on the printing medium M with ultraviolet rays may be disposed, instead of the prestage dryer 4 and the post-stage dryer 8.

The present invention can be applied to general printing technology.

As described above, the printing apparatus may be configured so that the second negative pressure applying part has a second solenoid valve connected to the recovery tank, the first negative pressure applying part has a third solenoid valve connected to the supply tank, the first negative pressure applying part further has a first negative pressure pump, and a first negative pressure tank decompressed by the first negative pressure pump and applies a negative pressure generated in the first negative pressure tank by the first negative pressure pump to the supply tank through the third solenoid valve, and the third solenoid valve causes the supply tank and the first negative pressure tank to communicate with each other when being energized and cuts off the supply tank and the first negative pressure tank from each other when not being energized, the second negative pressure applying part further has a second negative pressure pump, and a second negative pressure tank decompressed by the second negative pressure pump and applies a negative pressure generated in the second negative pressure tank by the second negative pressure pump to the recovery tank through the second solenoid valve, the second solenoid valve causes the recovery tank and the second negative pressure tank to communicate with each other when being energized and cuts off the recovery tank and the second negative pressure tank from each other when not being energized. In such a configuration, it is possible to maintain a state in which the negative pressure is generated inside each of the first negative pressure tank and the second negative pressure tank even during a power failure. It thereby becomes possible to quickly generate a negative pressure in each of these negative pressure tanks in a recovery from the power failure.

The printing apparatus may be configured so that the first negative pressure applying part further has a first negative pressure tube that is flexible and connected to the first negative pressure tank, and applies the negative pressure generated in the first negative pressure tank by the first negative pressure pump to the supply tank through the first negative pressure tube, and the second negative pressure applying part further has a second negative pressure tube that is flexible and connected to the second negative pressure tank, and applies the negative pressure generated in the second negative pressure tank by the second negative pressure pump to the recovery tank through the second negative pressure tube. In such a configuration, each of the flexible negative pressure tubes is bent into a U-shape by its own weight or a piping path. For this reason, if the ink overflowed from the recovery tank flows into the second negative pressure tube during the power failure, the ink is accumulated in the lowest portion of the second negative pressure tube and it thereby becomes necessary to perform an operation of removing the accumulated ink in the recovery from the power failure. In contrast to this, in the present invention, it is possible to suppress the inflow of the ink overflowed from the recovery tank into the second negative pressure tube of the second negative pressure applying part during the power failure and reduce the operation required in the recovery from the power failure.

The printing apparatus may be configured so that the first negative pressure applying part further has a first check filter that inhibits passage of ink while permitting passage of gas in a direction from the supply tank toward the first negative pressure tank and prevents inflow of ink from the supply tank to the first negative pressure tube by the first check filter, and the second negative pressure applying part further has a second check filter that inhibits passage of ink while permitting passage of gas in a direction from the recovery tank toward the second negative pressure tank and prevents inflow of ink from the recovery tank to the second negative pressure tube by the second check filter. The second check filter can be used for the purpose of preventing the inflow of the ink from the recovery tank into the second negative pressure tube due to some cause, which is not limited to the power failure. When the second check filter is wet with the ink, however, the aeration property required for the second check filter is reduced. For this reason, when the ink overflowed from the recovery tank toward the second negative pressure tube flows into the second check filter during the power failure, it becomes necessary to perform an operation of replacing the second check filter with another one in the recovery from the power failure. In contrast to this, in the present invention, it is possible to suppress the inflow of the ink overflowed from the recovery tank into the second check filter of the second negative pressure applying part during the power failure and reduce the operation required in the recovery from the power failure.

A printing system according to the invention, comprises: aforementioned printing apparatus; and a drying apparatus configured to dry ink discharged onto a printing medium by the printing apparatus. Therefore, it becomes possible to suppress the overflow of the ink into the negative pressure supply part when the circulation pump which circularly supplies the ink to the discharge head is stopped due to the power failure.

Although the invention has been described with reference to specific embodiments, this description is not meant to be construed in a limiting sense. Various modifications of the disclosed embodiment, as well as other embodiments of the present invention, will become apparent to persons skilled in the art upon reference to the description of the invention. It is therefore contemplated that the appended claims will cover any such modifications or embodiments as fall within the true scope of the invention.

What is claimed is:

1. A printing apparatus, comprising:
a discharge head that discharges ink from a nozzle;
a recovery tank that stores ink recovered from the discharge head;
a supply tank that stores ink to be supplied to the discharge head;
a circulation pump that transfers the ink from the recovery tank to the supply tank with supplied electric power to perform an ink circulation operation of circulating ink in a circulation path that returns to the recovery tank after reaching the discharge head from the recovery tank via the supply tank;
a first negative pressure applying part configured to apply a negative pressure to the inside of the supply tank;
a second negative pressure applying part configured to apply a negative pressure to the inside of the recovery tank;
a first solenoid valve provided between the supply tank and the recovery tank, to cut off the supply tank and the recovery tank from each other when being energized and cause the supply tank and the recovery tank to communicate with each other when not being energized; and
a power supply part configured to supply electric power to the circulation pump and the first solenoid valve.

2. The printing apparatus according to claim 1, wherein
the second negative pressure applying part has a second solenoid valve connected to the recovery tank,
the first negative pressure applying part has a third solenoid valve connected to the supply tank,
the first negative pressure applying part further has a first negative pressure pump, and a first negative pressure tank decompressed by the first negative pressure pump and applies a negative pressure generated in the first negative pressure tank by the first negative pressure pump to the supply tank through the third solenoid valve, and
the third solenoid valve causes the supply tank and the first negative pressure tank to communicate with each other when being energized and cuts off the supply tank and the first negative pressure tank from each other when not being energized,
the second negative pressure applying part further has a second negative pressure pump, and a second negative pressure tank decompressed by the second negative pressure pump and applies a negative pressure generated in the second negative pressure tank by the second negative pressure pump to the recovery tank through the second solenoid valve,
the second solenoid valve causes the recovery tank and the second negative pressure tank to communicate with each other when being energized and cuts off the recovery tank and the second negative pressure tank from each other when not being energized.

3. The printing apparatus according to claim 2, wherein
the first negative pressure applying part further has a first negative pressure tube that is flexible and connected to the first negative pressure tank, and applies the negative pressure generated in the first negative pressure tank by the first negative pressure pump to the supply tank through the first negative pressure tube, and
the second negative pressure applying part further has a second negative pressure tube that is flexible and connected to the second negative pressure tank, and applies the negative pressure generated in the second negative pressure tank by the second negative pressure pump to the recovery tank through the second negative pressure tube.

4. The printing apparatus according to claim 3, wherein
the first negative pressure applying part further has a first check filter that inhibits passage of ink while permitting passage of gas in a direction from the supply tank toward the first negative pressure tank and prevents inflow of ink from the supply tank to the first negative pressure tube by the first check filter, and
the second negative pressure applying part further has a second check filter that inhibits passage of ink while permitting passage of gas in a direction from the recovery tank toward the second negative pressure tank and prevents inflow of ink from the recovery tank to the second negative pressure tube by the second check filter.

5. A printing system, comprising:
the printing apparatus according to any claim 1; and
a drying apparatus configured to dry ink discharged onto a printing medium by the printing apparatus.

6. A printing method, comprising:
performing a printing operation of discharging ink from a nozzle of a discharge head while transferring the ink from a recovery tank to which a negative pressure is applied to a supply tank to which a negative pressure is applied by a circulate pump to which electric power is supplied to circulate ink in a circulation path that returns to the recovery tank after reaching the discharge head from the recovery tank via the supply tank; and
supplying electric power to a solenoid valve provided between the supply tank and the recovery tank in parallel with the printing operation,
wherein the solenoid valve cuts off the supply tank and the recovery tank from each other when being energized and causes the supply tank and the recovery tank to communicate with each other when not being energized.
